(19) United States
(12) Patent Application Publication
(10) Pub. No.: US 2019/0139136 A1
(43) Pub. Date: May 9, 2019

(54) SYSTEMS AND METHODS FOR TRADING, CLEARING AND SETTLING SECURITIES TRANSACTIONS USING BLOCKCHAIN TECHNOLOGY

(71) Applicant: TEMPLUM, INC., New York, NY (US)

(72) Inventors: Vincent Molinari, Laurel Hollow, NY (US); Joe Latona, Monroe Township, NJ (US); Christopher J. Pallotta, New York, NY (US); Clifford H. Friedman, Huntington Bay, NY (US)

(21) Appl. No.: 16/209,626

(22) Filed: Dec. 4, 2018

Related U.S. Application Data
(63) Continuation of application No. 15/198,136, filed on Jun. 30, 2016.
(60) Provisional application No. 62/190,567, filed on Jul. 9, 2015.

(51) Int. Cl. G06Q 40/04; G06Q 20/36; H04L 29/08; H04L 9/06

(52) U.S. Cl. CPC G06Q 40/04; H04L 9/0637; H04L 67/1042; G06Q 20/363

(57) ABSTRACT

The present invention relates to a securities trading system that utilizes a distributed blockchain ledger to conduct security transactions. Users are provided with cryptographic wallets that enable the users to access a peer-to-peer network of computing nodes on which the distributed blockchain ledger is managed. The securities made available through the network may be stored directly on the blockchain ledger itself. Smart contracts may be utilized to transfer the securities among the users and to verify that all transactions are in compliance with applicable regulatory rules and other restrictions.

### CROSS-REFERENCE TO RELATED APPLICATIONS

This application is a continuation of, and claims priority to, U.S. patent application Ser. No. 15/198,136 filed on Jun. 30, 2016, which claims benefit to U.S. Provisional Application No. 62/190,567 filed on Jul. 9, 2015. The contents of the aforementioned applications are herein incorporated by reference in their entireties.

### FIELD OF THE INVENTION

The present principles are directed to systems and methods for providing a trading system and platform and, more particularly, to providing a trading, clearance, settlement, and depository platform for securities, commodities, and derivatives (collectively referred to herein as “securities”) that utilizes virtualized data tokens and blockchain technology to facilitate transactions.

### BACKGROUND OF THE INVENTION

Various options currently exist that enable trading, clearance and settlement of securities electronically over the Internet. For example, there are a number of websites that permit issuers to list security products for auction or sale. The securities listed on these websites may be purchased in the traditional manner. For example, investors may create accounts that enable them to submit bids or purchase the securities.

These conventional systems are plagued with a number of deficiencies. One major problem is that these systems are not efficient because they lack the technological infrastructure to process transactions quickly and securely. Instead, existing systems process transactions in a fragmented manner that requires participation of several different actors. For example, an exchange or other organization may initially be responsible for vetting new issuers or offerings, while trading platforms list the offerings and banking institutions or separate clearing houses are responsible for settling and clearing the transactions. Clearing and settling transactions is usually performed through a slow, back-office process that takes several days. Another impediment that hinders the processing of the transactions is that investors and issuers are often required to submit and execute hard copies of various master agreements, or other documents for certain transactions.

Another problem associated with conventional trading systems is a lack transparency with respect to the transaction histories of the security products. For example, it is difficult or impossible to determine the individuals or entities who previously owned a particular security. This is due to the fact that there is no technological infrastructure in place that permits the documents associated with the previous transactions involving a security to be accessed immediately in real-time.

Conventional trading, clearance, and settlement systems also do not facilitate efficient lending and borrowing of securities. Currently, a borrower of securities must post collateral to secure their borrowing for the duration of the loan. The lender and the borrower of the securities must then market the securities borrowed on a daily basis to ensure the amount of collateral pledged to secure the loan is sufficient to cover the value of the loaned securities. The lending and borrowing of securities is also complicated by the fact that, at any moment, a lender of securities may need to recall the securities.

In view of the foregoing, there is a need for a comprehensive electronic trading system in which assets and transactions can be processed efficiently and traded through in a more transparent and accessible manner. There is further a need for such a trading system to provide a technological framework that standardizes the electronic exchange of securities and permits instantaneous verification of transaction histories associated with the securities.

### SUMMARY OF THE INVENTION

The present invention relates to systems and methods for issuing, trading, clearing and settling security transactions using a distributed blockchain ledger. Users are provided with cryptographic or virtual wallets. The cryptographic wallets enable the users to access a peer-to-peer network of computing devices on which the distributed blockchain ledger is managed. The securities made available through the network are embedded directly onto blockchain ledger itself. An embedded security may include base security documents, a set of security rules and ownership information. Smart contracts may be utilized to transfer the securities among the users and to verify that all transactions are in compliance with applicable regulatory rules and other restrictions.

In accordance with certain embodiments, a computerized system for managing securities over a network is disclosed. The system includes a plurality of computing devices that are in communication with one another over a peer-to-peer communication network. Each of the computing devices includes a processor and a physical storage medium that stores at least a portion of a distributed blockchain ledger that includes a distributed database that records information associated with security transactions that occur on the peer-to-peer communication network.

The storage medium may further store a cryptographic wallet that includes encryption protocols for securely storing a virtual portfolio of securities. The cryptographic wallet includes a first set of protocols for issuing securities. The first set of protocols are configured to store issued securities directly on the distributed blockchain ledger itself by utilizing a one-way hashing algorithm to append one or more blocks to the distributed blockchain ledger. The one or more blocks at least include base security documents associated with the securities being issued, sets of security rules which indicate regulations and restrictions which apply to the securities, and ownership identifiers which identify one or more owners of the securities. The cryptographic wallet further includes a second set of protocols for transferring ownership of the securities to cryptographic wallets stored on other computing devices on the peer-to-peer communication network.

In accordance with certain embodiments, a method for managing securities over a network is disclosed. The method includes the steps providing a plurality of computing devices with access to a peer-to-peer communication network, and storing at least a portion of a distributed blockchain ledger on the plurality of computing devices. The distributed blockchain ledger includes a distributed database that records information associated with security transactions that occur on the peer-to-peer communication network.

The method further includes the step of storing a cryptographic wallet that includes encryption protocols for securely managing a virtual portfolio of securities. The cryptographic wallet may further include a first set of protocols for issuing securities. The first set of protocols are configured to store issued securities directly on the distributed blockchain ledger itself by utilizing a one-way hashing algorithm to append one or more blocks to the distributed blockchain ledger. The one or more blocks at least include base security documents associated with the securities being issued, sets of security rules which indicate regulations and restrictions which apply to the securities, and ownership identifiers which identify one or more owners of the securities. The cryptographic wallet may further include a second set of protocols for transferring ownership of the securities to cryptographic wallets stored on other computing devices on the peer-to-peer communication network.

These and other features and advantages will become apparent from the following detailed description of illustrative embodiments thereof, which is to be read in connection with the accompanying drawings.

### BRIEF DESCRIPTION OF DRAWINGS

The inventive principles are illustrated in the figures of the accompanying drawings which are meant to be exemplary and not limiting, in which like references are intended to refer to like or corresponding parts, and in which:

FIG. 1 is a block diagram of a system configured to issue, manage and exchange securities or other assets in accordance with certain embodiments of the present invention.

FIG. 2 is a diagram illustrating the creation of a virtual security instrument in accordance with certain embodiments of the present invention.

FIG. 3 is a flow diagram that illustrates an exemplary method for transferring ownership of a security in accordance with certain embodiments of the present invention.

FIG. 4 is a flow diagram that illustrates an exemplary method for implementing a pooled investment fund in accordance with certain embodiments of the present invention.

FIG. 5 is a flow diagram that illustrates an exemplary method for managing securities in accordance with certain embodiments of the present invention.

### DESCRIPTION OF EXEMPLARY EMBODIMENTS OF THE INVENTION

The present invention relates to a technological infrastructure that utilizes specialized cryptographic and tokenization protocols for securely creating, trading, clearing, settling and authenticating transactions associated with securities. The technological infrastructure may include a web-based or cloud-based platform that is accessible over a network using computing devices operated by users (e.g., issuers, investors, administrators or other users). The users may download cryptographic wallets (which may also be referred to “virtual wallets” or “cryptographic portfolios”) from the platform and install the cryptographic wallets on the computing devices. The cryptographic wallets enable the users to access a distributed, peer-to-peer network that utilizes blockchain technology in various ways to facilitate security transactions. Interfaces provided by the cryptographic wallet and/or platform enable the users to perform trade-related functions (e.g., such as viewing investment information, issuing securities, and trading securities).

The peer-to-peer network may utilize a public or private blockchain which includes a ledger (which may also be referred to herein as a “blockchain ledger” or “titlechain ledger”) that is distributed among the computing devices on the network. In certain embodiments, the network utilizes a private, permission-based blockchain that is available to users who have downloaded cryptographic wallets and registered with the platform. When an issuer or other user creates a new security, the security and its associated data are stored directly on the ledger itself and are represented as one or more entries (or “blocks”) on the blockchain.

Generally speaking, the present techniques can be utilized to create or virtualize any instrument that has beneficial ownership of title and the instrument can be stored on the blockchain. In certain embodiments, smart contracts may be utilized to onboard new issuers and new securities that are being offered. For each security that is created, the blockchain may be appended with an entry that includes a dataset that represents the security itself. An exemplary dataset may include any data or information that is relevant to the security including, but not limited to, data that identifies the type of security, the issuer, the offering associated with the security, regulatory rules that apply to the security, restrictions that apply to the security (e.g., right of first refusal restrictions, accredited investor restrictions, etc.), documentation pertaining to the security, ownership data, and other related information. In certain embodiments, some or all of the dataset associated with the security (including related files or documentation) may be stored on a server and the entry in the blockchain corresponding to the security may include a key or cypher than enables the data to be unlocked and retrieved. Once a security is created, investors can access the system to obtain “Actionable Knowledge™” that provides comprehensive and detailed information pertaining to all available securities, thus providing investors with the information necessary to make decisions regarding transactions.

The users' cryptographic wallets may include specialized cryptographic and tokenization protocols which are employed to update the blockchain ledger and exchange virtualized data tokens among the cryptographic wallets in order to facilitate trading and authenticating of securities. As explained in further detail below, the platform converts the securities into virtual data token instruments that can be exchanged among the users' cryptographic wallets based on the transactions that are recorded on the blockchain ledger. The blockchain ledger provides an audit trail that can be utilized in real-time to track and validate all transactions involving the data tokens. All transactions, including previous transactions that resulted in an exchange of a security, can be self-verified instantly using the audit trail provided by the blockchain, thus providing a high level of transparency and protection to all interested individuals.

In certain embodiments, the cryptographic wallets can utilize or analyze the blockchain history to determine which data tokens should be included in a user's cryptographic wallet. The virtual data tokens may include embedded data that travels with the tokens throughout their lifecycle, starting with the initial issuance of the security and continuing as the security is exchanged on secondary markets. Some or all of the embedded information may also be recorded on the distributed blockchain ledger that is maintained by network. The embedded information may include any data associated with any transaction involving the securities, any parties to the transactions, and/or any data about the asset itself. Instead of embedding large documents (or an impractically large amount of data) into the virtual data tokens, the tokens may include a key or cypher that is used to unlock and securely access the documents (e.g., which may be stored on the cloud-based portion of the platform). The system is able to process transactions quickly and efficiently because a centralized banking institution is not required to perform clearance and settlement functions. Furthermore, because the record keeping or auditing process for all transactions is “dematerialized” (e.g., conducted and stored electronically without need for physical papers or handwritten signatures), all of the relevant documentation is immediately available to the secondary market.

In certain embodiments, smart contracts may be utilized to perform a variety of functions including, but not limited to, transferring ownership of securities, onboarding new securities, and onboarding issuers and onboarding investors. The smart contracts may be implemented using one or more event-driven programs and protocols that utilize the blockchain ledger to facilitate, verify, execute and enforce the terms of an agreement related to implementing these functions. The programs and protocols associated with the smart contracts may be incorporated into the cryptographic wallets or otherwise made available through the platform.

In certain embodiments, an entry in a blockchain ledger pertaining to a security may include information that enables a master account (e.g., a family office account) to provide permissions to one or more sub-accounts (e.g., a sub-account in the family office) which enable the sub-accounts to access, sell or otherwise utilize a security. Entries in the blockchain which pertain to the security may identify the master account as the owner of the security and may further include parameters or fields that identify sub-accounts that have been granted the permissions. A user associated with the master account can grant or remove permissions to the security as needed. An entry may be appended to the blockchain each time permissions are updated so that the system at all times can determine whether a particular account has permissions to access, sell or otherwise utilize a security.

In certain embodiments, the system enables a fund to be created by pooling together investments from a plurality of investors or other users. To join the fund, each user may initially execute a smart contract. Once created, the fund may be utilized to deploy capital in various ways. In certain embodiments, the fund deploys capital to individuals who are seeking to borrow. The fund may be represented and stored directly on the blockchain. All borrowing and/or repayment transactions may be recorded on the blockchain.

Although the present disclosure primarily describes the platform in terms of securities trading, clearance, settlement, and lending, it should be recognized that the principles described herein can be utilized to exchange any type of asset, including any type of physical or digital asset, and is not limited to exchanging or trading securities.

The inventive principles discussed herein provide a variety of advantages. They allow for a comprehensive and self-managing electronic trading system in which assets and transactions can be processed quickly and efficiently without requiring actions by multiple actors (e.g., associated with exchanges, clearing houses, etc.) and without requiring hard copies of documents. The blockchain-enabled techniques provide a technological framework which permits securities to be exchanged in a more transparent and accessible manner. Because the blockchain ledger maintains a record of all transactions, the system allows for instantaneous verification of transaction histories associated with the securities, thus removing counter party risks.

These advantages are accomplished using a technological framework that relies on novel protocols for communicating with nodes or computing devices in a peer-to-peer network that maintains a distributed database. The protocols are incorporated, at least in part, into a new type of cryptographic wallet which is configured to utilize smart contracts in connection with certain transaction activities prior to appending blocks to distributed blockchain database. The cryptographic wallet further utilizes hashing techniques to store assets directly on the blockchain ledger itself, while securely protecting assets stored in the wallet using encryption techniques. These and other technical aspects of the invention provide a technological framework that for managing security transactions that is efficient, transparent and self-managing, and which overcomes the shortfalls associated with prior art systems.

The embodiments described in this disclosure can be combined in various ways. Any aspect or feature that is described for one embodiment can be incorporated into any other embodiment mentioned in this disclosure. Moreover, any of the embodiments described herein may be hardware-based, software-based and preferably comprise a mixture of both hardware and software elements. Thus, while the description herein may describe certain embodiments, features or components as being implemented in software or hardware, it should be recognized that any embodiment, feature or component that is described in the present application may be implemented in hardware and/or software.

Embodiments may include a computer program product accessible from a computer-usable or computer-readable medium providing program code for use by or in connection with a computer or any instruction execution system. A computer-usable or computer-readable medium may include any apparatus that stores, communicates, propagates or transports the program for use by or in connection with the instruction execution system, apparatus, or device. The medium can be a magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modems and Ethernet cards are just a few of the currently available types of network adapters.

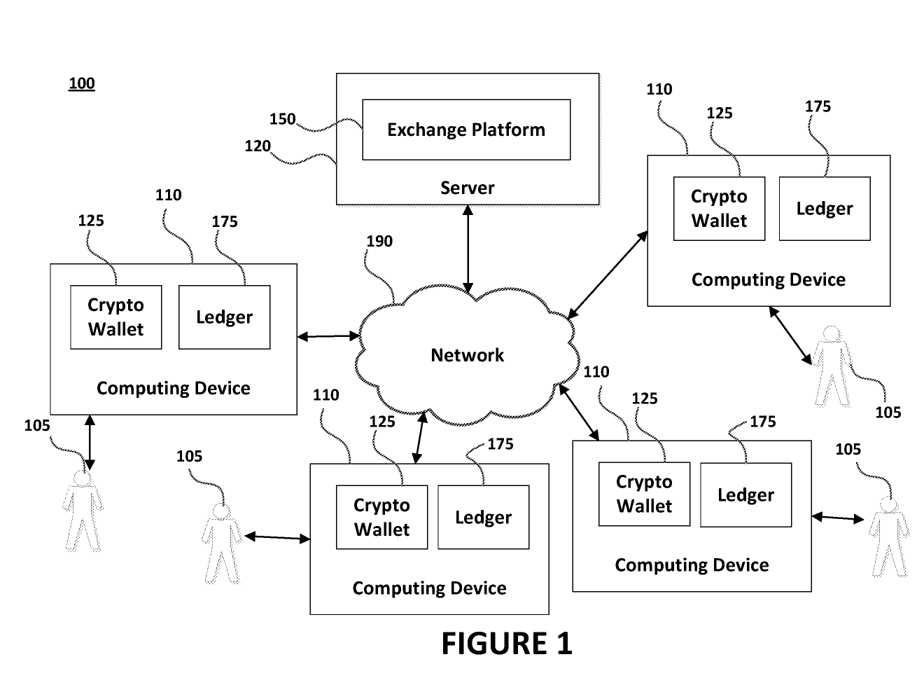

Referring now to the drawings in which like numerals represent the same or similar elements and initially to FIG. 1, an exemplary system 100 is disclosed for managing and exchanging securities or other assets over a network 190. The system 100 includes a securities platform 150 that is hosted on one or more servers 120. In certain embodiments, the platform 150 may represent a web-based or cloud-based platform that may be accessed over a network 190 by computing devices 110 operated by users 105, such as issuers, investors, administrators or other users. The network 190 may be any type of network such as one that includes the Internet, a local area network, a wide area network, an intranet, a peer-to-peer network, and/or other network. The computing devices 110 store a distributed blockchain ledger 175 and cryptographic wallets 125 which enable the users 105 to issue securities, trade securities and perform other related functions across the network 190 in a secure and reliable manner.

The platform 150 may be hosted on a server 120, or a plurality of servers 120, that are configured to communicate with the computing devices 110 operated by the users 105. The computing devices 110 may represent desktop computers, laptop computers, mobile devices (e.g., smart phones or personal digital assistants), tablet devices, or other type of computing devices. The computing devices 110 and the servers 120 may be configured to communicate via wired or wireless links, or a combination of the two. Each may be equipped with one or more computer storage devices (e.g., RAM, ROM, PROM, SRAM, etc.) and one or more processing devices (e.g., central processing units) that are capable of executing computer program instructions. The computer storage devices are preferably physical, non-transitory mediums.

The platform 150 and system 100 may be accessed using a web browser, an application programming interface (“API”), an order management system (“OMS”) or an execution management system (“EMS”) sponsored by a third party, or a client application that is installed on the computing devices 110. In certain embodiments, certain aspects of the system 100 or platform 150 may be utilized for offering and transferring securities. In other embodiments, certain aspects of the system 100 or platform 150 may be incorporated into an OMS that assists with entering and processing security transactions, an EMS that provides and/or predicts market data, and/or a quality management system that assists with ensuring quality of service to customers.

Users 105, such as issuers, investors and administrators, interacting with the system 100 may be provided with cryptographic wallets 125 (or virtual portfolio) and accounts that are hosted on the platform 150 to assist the users 105 with performing the functions described herein. Issuer users 105 may utilize the cryptographic wallets 125 and/or accounts to list securities for auction or sale. Investor users 105 can utilize the cryptographic wallets 125 and/or accounts to browse, bid on, purchase and/or sell securities being offered or traded on the system 100.

Administrator users 105 can utilize the cryptographic wallets 125 and/or accounts to provide assistance to issuers and investors, and to assist with facilitating the trading of securities among the users 105. The issuers and investors may represent individuals or entities (e.g., financial institutions, companies, governmental, or other organizations) seeking to sell or acquire securities, and the administrators may represent individuals who are employed by a company or organization that operates, manages and maintains the platform 150.

The securities that are exchanged may be newly issued securities on a primary market, existing securities available for trading on a secondary market, or unregistered securities that are available for trading in the over the counter market (“OTC”). The system 100 can be configured to enable a primary issuance or secondary trading of any type of security. Exemplary securities that may be made available include, but are not limited to, debt securities (e.g., banknotes, bonds and debentures), equity securities (e.g., common stocks, preferred stocks and limited partnership interests), and derivatives (e.g., forwards, futures, options, warrants and swaps). The securities may be registered or unregistered securities. Regardless of which securities are made available, the platform 150 and cryptographic wallets 125 are preferably configured in a manner that is compliant with all applicable governmental laws and regulations.

In contrast to conventional security trading systems which inefficiently perform trade-related activities (e.g., such as issuing securities and clearing/settling transaction) with a variety of different actors, the system 100 described herein provides an alternative investment market in which all offering and trading activities are conducted through a single system that utilizes a blockchain-based, peer-to-peer network 190 of computing devices 110 to conduct transactions. The system 100 is configured to manage all activities associated with exchanging securities, starting from the issuance of the securities and continuing throughout the lifecycles of the securities. It relies on a distributed framework that enables real-time clearance and settlement of transactions, thus providing an alternative investment market which is very liquid in comparison to existing markets and which removes counterparty risks. Certain embodiments of the system 100 may also be configured to permit efficient borrowing and lending of securities.

The platform 150 utilizes blockchain and virtual data token technology to provide a compliant framework for issuing, trading, archiving, clearing, settling, and recording securities transactions. Each time a user 105 desires to list or trade a security, the user's cryptographic wallet 125 can provide access to a peer-to-peer network 190 in which the distributed blockchain ledger 175 is stored on and maintained by the users' computing devices 110. The blockchain ledger 175 may be utilized to facilitate transactions on the system 110 in several different ways, including those which involve listing and creating securities, transferring ownership of the securities, permissioning users and accounts for controlling the securities and pooling securities to deploy capital in various ways.

The cryptographic wallets 125 may be implemented in software and/or hardware. The cryptographic wallets may operate similarly to wallets utilized by virtual currencies, such as BitCoin, in certain respects. However, in addition to storing virtual currencies, the cryptographic wallet 125 utilized by the system 100 may be additionally configured to implement a “cryptographic portfolio” that can create, store, transfer and manage virtual data tokens associated with securities and other related information.

The cryptographic wallets 125 utilize complex cryptography to protect the assets of the users 105, and further include code or instructions that implement a protocol for exchanging data tokens, creating new security offerings, transferring ownership of the securities, pooling investments, and/or performing any other associated activities (e.g., such as generating and utilizing cryptographic keys, generating local and network messages, updating ledgers, etc.). When conducting transactions that involve the exchange or transfer of data tokens, the protocols can decrypt the necessary information associated with the appropriate blocks on the blockchain ledger 175 and validate the transactions among sellers and purchasers by checking the information stored in the blockchain ledger 175. The cryptographic wallets 125 may also be used for administering and transferring currencies or funds (e.g., crypto currencies or non-crypto currencies and funds), which can be used to purchase assets that are listed on the system 100.

The cryptographic wallets 125 may enable users 105 to engage in smart contracts for facilitating a variety of different functions. For example, the cryptographic wallets 125 may provide smart contracts that enable users 105 to transfer ownership of securities and onboard new securities. Smart contracts may also be utilized to onboard issuers and investors. Each smart contract offered by the cryptographic wallet 125 may include one or more event-driven programs and associated protocols for performing these functions. The smart contracts may utilize the blockchain ledger 175 to facilitate, verify, execute and enforce the terms of an agreement related to implementing these functions. The blockchain ledger 175 may be appended to reflect the performance, or lack of performance, of any events and criteria associated with the contracts.

The smart contract may be embedded or configured with measures to ensure compliance with regulatory rules, such as rules associated with anti-money laundering laws, any Blue Sky laws, the Financial Industry Regulatory Authority (FINRA) (e.g., Know-Your-Customer rules), the Security Exchange Commission (SEC), the Bank Secrecy Act (BSA), international requirements, or other types of regulatory measures. The smart contract may be embedded or configured with measures to ensure compliance with restrictions imposed on the securities, such as restrictions associated with rights of first refusal, accredited investor statuses, convertible instruments, time restrictions on security transfers, restrictions imposed by the stock series, or other types of restrictions.

A smart contract for transferring ownership of a security asset may be initiated by a buyer (e.g., an investor user 105) or seller (e.g., another investor user 105 or an issuer user 105) initiating a transfer contract. Information may be gathered to verify that the parties are eligible to conduct the transaction (e.g., to verify a buyer is an accredited investor and to verify a seller owns the security which is the subject of the transaction). This information may be supplied by the parties themselves or ascertained from the blockchain ledger 175 using automated programs or scripts associated with the smart contract. The smart contract may be embedded with measures to ensure compliance with any regulatory rules (e.g., Blue Sky, FINRA or SEC rules and laws) or restrictions (e.g., governing the right of first refusal, accredited investor status or other restriction) which apply to the transfer. The parties may then agree upon the terms of the transfer (e.g., price, quantity, timeframe, etc.). The buyer's currency (e.g., conventional monetary funds or crypto currency) may then be placed under the control of the contract. The automated protocols underlying the contact may automatically transfer ownership of the security in exchange for the currency once it is determined that the contractual terms are satisfied, and that the parties to the contract have adhered to all relevant regulatory rules and other restrictions. In certain embodiments, the blockchain ledger 175 may be updated and appended to reflect performance, or lack thereof, of any events associated with the smart transfer contract. For example, the blockchain ledger 175 may be updated and appended when a trade is initiated, when events occur (or do not occur), when information is supplied (or not supplied), and when the trade is confirmed or denied.

After a transfer contract is successfully confirmed, the cryptographic wallets 125 associated with the users 105 may append an entry to the ledger 175 that indicates completion of the contract and the change in the security's ownership. The entry that is appended to the ledger 175 may reference the blocks in the ledger 175 pertaining to the dataset associated with the security in order to indicate updated ownership of the security and provide a proper audit trail. In response to the ledger 175 being appended, a virtual data token associated with the security may be transferred from the cryptographic wallet 125 of the seller to the cryptographic wallet 125 of the buyer.

In certain embodiments, users 105 may change permission information appending blocks to the blockchain ledger 175. For example, an entry may be added to the blockchain ledger 175 that enables a master account (e.g., a family office account) to provide permissions to one or more sub-accounts which enable the sub-accounts to access, sell, purchase or otherwise interact with securities on behalf of the master account. The entry may identify the master account (e.g., using an investor or issuer identification or ID) as the owner of the security and may further include parameters or fields that identify sub-accounts (e.g., again, using an investor or issuer ID) that have been granted the permissions. A user 105 associated with the master account can grant or remove permissions to the security when it is desired to do so. An entry may be appended to the blockchain ledger 175 each time permissions are updated.

In certain embodiments, the system 100 enables a pooled fund to be created by combining investments from a plurality of investors or other users 105. The fund may be represented and stored directly on the blockchain. Each investor user 105 may initially execute a smart contract that is provided via the cryptographic wallet 125 and which enables the investor to join the fund. In certain embodiments, the pooled fund may be utilized to invest in one or more of the securities offered on the system 100. In certain embodiments, the pooled fund may also, or alternatively, be used to loan or give money to other users 105. Each borrower user 105 may also execute a smart contract that is provided via the cryptographic wallet 125 and which enables the borrower to borrow from the fund. The borrowers can submit money to the fund to repay the loan. All investing, borrowing and/or repayment transactions may be recorded on the blockchain. In certain embodiments, permissions may be assigned by master accounts to sub-accounts to provide control of the pooled fund.

In certain embodiments, the virtual data tokens may be used to represent the securities (e.g., shares) made available and exchanged among the users' 105 cryptographic wallets 125. For example, if an issuer desires to undertake an initial primary offering that lists a thousand shares on the platform 150, each share may be represented by a separate data token (or token, coin, digital representation or the like) or a data token may represent a plurality of the shares. The data tokens may then be transferred to investors based on the exchanges that take place using the blockchain techniques described herein.

The data tokens and blockchain ledger 175 may be embedded with information pertaining to the security product, its ownership, its issuer and any other relevant information. In certain embodiments, the data tokens and blockchain ledger 175 include a subset of information that relates to a base security document used to create the security, a subset of information that pertains to the investor who owns the security (and possibly also previous owners), a subset of information that pertains to the issuer, and a subset of information that specifies regulatory rules and restrictions that apply to the security. Exemplary information that may be embedded into the data tokens and blockchain ledger 175 may include:

(1) Issuer ID: Before an issuer is permitted to list securities on the system, the issuer may submit a request (e.g., via a web-based input form or cryptographic wallet 125) to create an issuer account on the platform 150 or system 100. In certain embodiments, an administrative user 105 may be required to approve the request. Upon approval of the request, the issuer user 105 is assigned an ID (e.g., consisting of alphanumeric characters) which uniquely identifies the issuer, the issuer's cryptographic wallet 125 and/or its associated account. The platform 150 or system 100 may embed the ID into all data tokens and blockchain entries associated with securities that are offered by the issuer.

(2) Investor ID: Before an investor is permitted to buy or sell securities, the investor may be required to submit a request to create an investor account on the platform 150 or system 100. In certain embodiments, an administrative user 105 may be required to approve the request. Upon approval of the request, the investor may be assigned an ID that uniquely identifies the investor and its associated account. Each time the investor purchases a security on the platform, the embedded information of the associated data token and blockchain ledger 175 are updated with the investor's ID to indicate the new ownership of the security.

(3) Product ID: Each time an issuer desires to list a new offering, the issuer may be required to submit a request to create the new offering on the platform 150 or system 100. In certain embodiments, an administrative user 105 may be required to approve the request. Upon approval of the request, the platform assigns the new offering a unique ID which identifies the associated security and which is embedded into the data tokens and blockchain ledger 175 entries for the associated security.

(4) Security Type Data: The data tokens and blockchain ledger 175 may include embedded information that identifies the type of security (e.g., common stock or preferred stock) associated with each security being offered on the system 100.

(5) Regulatory and Restriction Data: The data tokens and blockchain ledger 175 entries may include embedded information that identifies restrictions that are imposed on the securities. For example, restrictions may be imposed on a security which prevent a purchaser from selling the security for a predetermined time after purchasing the security, or which require the purchaser to sell the security to a particular subset of investors. Other exemplary restrictions may relate to rights of first refusal, rights of last refusal, restrictions on transactions involving foreign individuals or entities, and/or compliance with blue sky laws or instances where state preemption is permitted. Before a data token is transferred to a new owner, the platform may analyze the restriction data of the data token to ensure that the restrictions are being abided by.

(6) Executive Summary and Documentation: The data tokens and blockchain ledger 175 may include embedded information that includes an executive summary, a comprehensive description for the security, base security documents related to the creation of the security, and other documentation. Alternatively, a link or cypher that is used to identify and/or access a location (e.g., via a network address associated with the platform 150) where this information can be retrieved.

(7) Transaction History: The data tokens and blockchain ledger 175 may include embedded information that identifies all previous purchasers and sellers that exchanged the security and/or any information relevant to any of the transactions involving the security.

(8) Share Amount: The data tokens and blockchain ledger 175 may include embedded information that identifies a number of security shares that are owned by an investor or which are the subject of a transfer transaction. In certain embodiments, each data token may represent a single share. In alterative embodiments, each data token may represent a plurality of shares.

(9) Investor Compliance Information: The data tokens and blockchain ledger 175 may include embedded information that indicates whether the investor who owns a security is deemed to be compliant with anti-money laundering laws, know your customer guidelines or other types of compliance regulations.

(10) Investor Suitability: The data tokens and blockchain ledger 175 may further include embedded information that indicates the types of securities that the owner of a security is permitted to engage in. For example, the suitability data may indicate that the owner is a foreigner (subject to Office of Foreign Asset Control regulation) or is not an accredited investor and, thus, barred from investing in certain types of securities. Therefore, the suitability data, along with compliance information and other relevant data embedded in the data tokens, serve an important role in removing counter party risk and fostering investor protection.

(11) Beneficial Ownership. The data tokens and blockchain ledger 175 may include information that indicates the identity of the ultimate beneficial owner of the security.

It should be recognized that any other relevant information may also be embedded into the data tokens, and that the embedded information may vary based on the type of security product. Any and all of the above data may also be embedded or included in entries that are added to the blockchain ledger 175.

Each time a security is transferred to an individual, the information embedded in the data token may be updated and a new block may be added to the blockchain ledger 175 which references one or more of the previous blocks associated with the security. The blocks on the ledger 175 record and confirm when and in what sequence transactions occur. The entries in the blockchain ledger 175 are used to track the exchange of securities and can be used to validate any and all transactions related to the securities. At any time, the blockchain ledger 175 will indicate the history and current ownership of all securities offered on the system 100.

Certain embodiments may or may not use data mining techniques to verify and/or create the blocks or entries on the blockchain ledger 175. In embodiments that utilize data miners for these or other purposes, any known data mining technique may be utilized.

The blockchain ledger 175 may be implemented utilizing a decentralized architecture in which the blockchain ledger 175 is stored and maintained on a plurality of computing nodes 110 (e.g., associated with issuers, investors and/or administrators) that form a peer-to-peer network 190. The blockchain ledger 175 may represent an immutable, append-only, ledger that maintains a distributed database providing details and timestamp information of all transactions that have ever taken place on the system 100. The protocols utilized by the cryptographic wallets 125 may be applied to implement a consensus-based system which requires a specific state or set of values to be agreed upon by some or all of the computing devices 110, without the need to trust or rely upon a centralized authority, in order to conduct transactions and append entries or blocks to the blockchain ledger 175. Any known consensus protocol may be utilized by the system 100.

Entries that are added to the blockchain ledger 175 may link to previous entries or blocks already included in the blockchain ledger 175. Each block being added to the blockchain ledger 175 may refer to the most recently added block (e.g., by referencing a hash value associated with the prior block) in the ledger 175 which is associated with the security, thus creating an audit trail that leads to the initial block or set of blocks associated with the issuance of the security. For example, the entries that are added to the blockchain ledger 175 for a particular security may link back to specific transactions that are associated with a particular offering involving the security and all entries pertaining to a transfer of the security (e.g., including those entries which relate to the transfer of the security using smart contracts). The linkage among the transactions in the blockchain ledger 175 permits the system 100 and computing nodes 110 to follow the chain backward in order to observe and verify all transactions associated with the securities and their associated virtual data tokens.

As mentioned above, the entries in the blockchain ledger 175 are embedded with information that is associated with each transaction. For example, each time a security is initially offered or is transferred, an entry may be added to the blockchain ledger 175 and the entry may include embedded information that identifies the seller, the purchaser, the issuer, the specific security that is the subject of the transaction, and any other relevant information associated with the transaction. This may involve incorporating associated investor IDs (for both the seller and purchaser), issuer IDs and product IDs into the entry.

Cryptographic hashing techniques (or other cryptography techniques) may be applied to the entries in the blockchain ledger 175. In certain embodiments, the cryptographic wallets 125 utilize a one-way hashing algorithm (e.g., such as SHA-256 or SHA-512) to append entries to the blockchain ledger 175. The hashing techniques may link the entries in the ledger with the data tokens and their associated data. In certain embodiments, a Product ID, Issuer ID or Investor ID (or any combination thereof) may be used as inputs to the hashing functions and/or as associated hash values, and the users' cryptographic wallets 125 may digitally sign the entries that are added to the blockchain ledger 175.

Generally speaking, the blockchain ledger 175 may be updated with new blocks to identify any event relevant to issuing or transferring securities and their associated data tokens. The blockchain ledger 175 may be updated to identify other types of events as well. For example, the blockchain ledger 175 may be updated when investors' rights in security products become vested (e.g., for stock options, retirement plans, employee stock ownership plans, 409A plans, rights of first refusals and rights of last refusals). In certain embodiments, the blockchain ledger 175 may also be updated to reflect events pertaining to restrictions that are imposed on securities. For example, the blockchain ledger 175 may be updated when a time period has lapsed during which an owner is prevented from selling its ownership in a security or when an investor has submitted adequate information to verify it is an accredited investor. The blockchain ledger 175 may also be updated to record any bids that are submitted (regardless of whether or not they are accepted), to record any event associated with borrowing and lending activities, and to identify any transactions that were denied and their reasons for denial. The blockchain ledger 175 may further be updated to record any events associated with smart contracts that are initiated or confirmed on the system 100, as well any events which indicate whether specific conditions of the smart contract were satisfied. The blockchain ledger 175 may be updated to record permissions that are granted to master accounts and sub-accounts, as well as to create and maintain pools of investments that can be utilized to deploy capital in various ways. The blockchain ledger 175 may be updated to indicate any other events that are relevant to the securities made available on the platform.

Preferably, the system 100 includes various features that permit issuers and investors to conduct all activities and transactions electronically through the platform using their computing devices 110 (e.g., by using e-signatures and other features that enable easy processing of documents and transactions) and without requiring any manual tasks to be performed using printed or hardcopy paperwork. In certain embodiments, the system 100 (e.g., via the platform 150 and/or cryptographic wallets 125) utilizes client relationship management (“CRM”) software to facilitate all functions in a regulatory compliant manner, including functions associated with onboarding tasks (e.g., onboarding of new issuers, investors or securities), facilitating the exchange of securities (e.g., for receiving bids or offers to purchase, and settling and clearing transactions) and archiving transactions. Additional details regarding several of these functions are described below.

Issuer Onboardinq

An individual, entity or other user 105 may submit a request to become an issuer on the system 100. The user 105 may be required to fill out an input form that is made accessible via the platform 150 or the cryptographic wallets 125, and which permits the user 105 to provide information and upload documents pertaining to the user 105. The information submitted by the potential issuer may be stored on the platform 150 and/or embedded on the blockchain ledger 175. This information can be made accessible to administrator users 105 on the back-end of the platform 150 or through cryptographic wallets 125 utilized by administrator users 105. An administrator user 105 may review the information submitted and determine whether the user 105 is eligible to be an issuer. If the administrator determines the potential issuer is eligible to be an issuer, the user 105 may be assigned a unique issuer ID and a user account is established that enables the user 105 to engage in transactions as an issuer. The user 105 may be provided a cryptographic wallet 125 that enables it to perform transactions relating to issuing securities. All or a portion of the above-described onboarding activities may be performed in connection with a smart contract that gathers the above-described information. The blockchain ledger 175 can be appended to reflect the initiation of the contract, performance of the contractual obligations and confirmation/denial of the contract. In certain embodiments, the onboarding of an issuer may be performed without the participation of the administrator user 105.

Security Onboarding

An approved issuer user 105 can submit a request, via the user's account on the platform 150 or its cryptographic wallet 125, to list a security or other asset on the system 100. Generally speaking, the issuer may be permitted to list any instrument that has beneficial ownership of title. In certain embodiments, the issuer is permitted to list any type of security including, but not limited to, debt securities, equity securities and derivatives. The issuer may be required to submit various information about the new security product that the issuer is requesting to list. For example, the issuer may provide information indicating the specific type of security product, the amount or number of securities that is to be listed, whether or not the offering is for a primary or secondary market, any regulatory information that may apply to the security and/or any restrictions that apply to the security. The information provided by the issuer may vary depending upon the type of security product. The information submitted by the potential issuer may be stored on the platform 150 and/or embedded on the blockchain ledger 175.

In certain embodiments, the onboarding of securities may be performed without the participation of an administrator user 105. In other embodiments, all requests submitted by issuers may be made available to administrator users 105 via accounts on the platform or their cryptographic wallets 125. The administrator users 105 can view any details, and track the progress of, any request that is submitted by the issuers. The administrator users 105 may vet the requests (e.g., for compliance with regulations and laws) and determine whether or not to approve the requests based on the information that is provided by the issuers. Upon approval of a request, the platform 150 or system 100 may create a new security product and assign it a unique product ID. The security product may be stored on the blockchain ledger 175. All or a portion of the above-described activities may be performed as part of a smart contract and the blockchain ledger 175 can be appended to reflect the initiation of the contract, performance of the contractual obligations and confirmation/denial of the contract.

Investor Onboardinq

An individual or entity may register an account with the platform to become an investor who is eligible to purchase and/or sell securities on the system 100. However, even before registering, the potential investor may be permitted to access the “actionable knowledge” on the platform which provides detailed information pertaining to the listed securities, but may be barred from engaging in any transactions until an account is registered and approved, and the user is provided with a cryptographic wallet 125. The platform 150 may store or include its own cryptographic wallet 125 which is utilized to access the information stored on the blockchain 175 and the retrieved information may be presented via the platform 150 (e.g., via a website).

The potential investor may be required to fill out an input form that is accessible via the platform 150 or a cryptographic wallet 125 in order to register an account. The potential investor may be required to provide personal information (e.g., name, e-mail address, residence address and other related information) and to accept the terms of use and other agreements associated with the platform 150. In certain embodiments, the potential investor may also apply to become an accredited investor. To do so, the potential investor may be required to sign a document attesting to accredited investor status and/or to submit additional information that proves the potential investor qualifies as an accredited investor or a qualified institutional buyer (“QIB”).

The information submitted by the potential investor may be stored on the platform 150 or blockchain ledger 175, and thereafter made accessible to administrator users 105. In certain embodiments, the information may also be made available to compliance and/or regulatory authorities. An administrator user 105 may review the information submitted by the potential investor and determine whether the potential investor is eligible to be an investor (and/or whether the potential investor qualifies as an accredited investor). This may include processing the information received from the potential investor in compliance with anti-money laundering laws and other regulations. If the administrator user 105 determines the potential investor is eligible to be an investor, the potential investor may be assigned a unique investor ID and an account may be established that enables the individual or entity to engage in transactions on the system 100. The user 105 may also be provided a cryptographic wallet 125 that enables it to purchase and sell securities on the system 100. All or a portion of the above-described activities may be performed as part of a smart contract and the blockchain ledger 175 can be appended to reflect the initiation of the contract, performance of the contractual obligations and confirmation/denial of the contract.

Transactions

Investor users 105 may utilize their cryptographic wallets 125 to submit bids or purchase requests for the securities that are made available on the system 100. The issuers may determine whether or not to accept the bids or purchase requests submitted by the investors. The transaction associated with each pending bid or purchase request may be assigned a unique transaction ID and may be appended to the blockchain ledger 175. The issuer and investor involved in the transaction, as well as any administrator that is assisting with facilitating the transaction, may track the progress of the transaction using interfaces that are available through the platform 150 or cryptographic wallets 125. All transfer transactions may be performed using a smart contract and the blockchain ledger 175 may be appended to include entries relating to the initiation of the contract, performance of the contractual obligations and confirmation/denial of the contract.

Settlement and Clearance

The settlement and clearance process begins each time a trade is initiated. In response to a trade being initiated, the purchaser and the seller are sent trade confirmations and agreements to be executed (e.g., via a smart contract). The particular confirmations and agreements that are sent to the parties can vary depending upon the type of securities being exchanged. In certain embodiments, all documents associated with the transactions are processed electronically (e.g., using e-signatures or the like) and accessible through the platform 150 or blockchain ledger 175. Escrow accounts offered and maintained by the platform 150 and/or via the cryptographic wallets 125 are used to exchange money between the parties. Both the purchaser and the seller can access interfaces on the platform 150 or their cryptographic wallets 125 which permit the parties to track the status of the transaction throughout the settlement and clearance process. After the transaction clears, the ownership of one or more virtual data tokens is transferred from the seller to the purchaser. This may involve updating the embedded information in the virtual data tokens and appending one or more entries to the blockchain ledger 175 associated with the transaction.

Securities Lending

Investors may utilize their accounts to lend or borrow securities on the system 100. Lenders may list or display securities that are eligible to be borrowed by one or more borrowers through the system 100. Borrowers may also solicit lenders to loan securities to them through the system 100. The transaction associated with each pending lending or borrowing transaction may be assigned a unique transaction ID. The lender and the borrowers involved in the transaction, as well as any administrator that is assisting with facilitating the transaction, may track the progress of the transaction using interfaces that are available through the platform 150 or cryptographic wallets 125. All lending transactions may be performed using a smart contract and the blockchain ledger 175 may be appended to include entries relating to the initiation of the contract, performance of the contractual obligations and confirmation/denial of the contract.

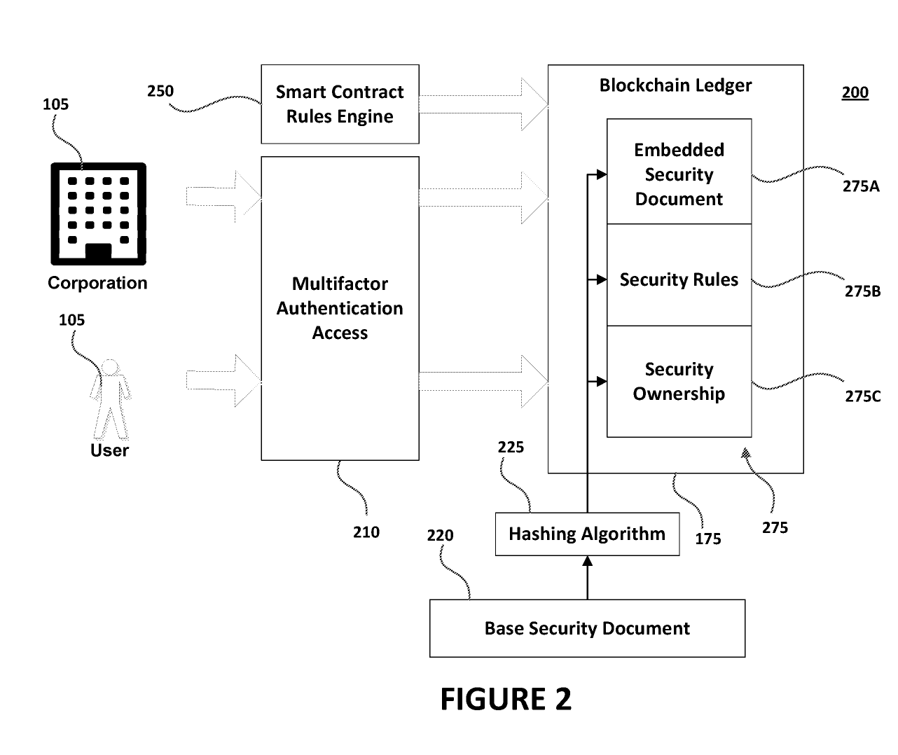

Moving on to FIG. 2, a diagram 200 is disclosed which illustrates the creation of a virtual security instrument in accordance with certain embodiments of the present invention. After a user 105 (e.g., an individual or entity) has been approved as an issuer, the issuer may submit a request to list a security on the system 100 by submitting a base security document 220 and other information that may be required. As explained above, the base security document 220 and information may be submitted via a smart contract that can be initiated using the issuer's cryptographic wallet 125 and/or via interfaces that are via the platform 150 and displayed through a browser or other application on the issuer's computing device 110. The base security document 220 may represent a contract or other documentation that is used to create a security, and which may specify the terms, regulations and restrictions that apply to the security. In certain embodiments, permitting an issuance of a new security offering may involve receiving an approval of an administrator user.

Once the issuer has provided all necessary information and the creation of a new security has been approved, a hashing algorithm 225 or function provided by the issuer's cryptographic wallet 125 is utilized to create and embed a new data block 275 (or set of data blocks 275) on the blockchain ledger 175 which represents the security itself. In certain embodiments, the issuer's cryptographic wallet 125 utilizes a one-way hashing algorithm (e.g., SHA-256 or SHA-512) to create the data block 275. Embedding the security into the blockchain ledger 175 may further involve using public-key cryptography techniques to embed the security into the blockchain ledger 175, whereby the cryptographic wallet 125 stores both a public key (e.g., which is publicly accessible to all nodes on the network 190 and which is used to encrypt data blocks and verify digital signatures) and a private key (e.g., which is secretly maintained by the cryptographic wallet 125 and which may be utilized to digitally sign blocks that are added to the blockchain ledger 175, decrypt encrypted text and securely maintain virtual data tokens in the cryptographic wallet 125). Prior to being added to the blockchain ledger 175, the new data block 275 being added to the blockchain ledger 175 may be validated and authenticated across the distributed peer-to-peer network 190.

The data block 275 which represents the new security may be mathematically linked to the issuer's cryptographic wallet 125 (e.g., to the private key stored in the cryptographic wallet 125) and may include at least three portions: an embedded security document portion 275A, a security rules portion 275B and an ownership portion 275C. While the figure illustrates the portions 275A, 275B and 275C as being included in a single data block 275 that is divided into logical subdivisions, it should be understood that the portions 275A, 275B and 275C may also be represented as separate data blocks 275 on the blockchain ledger which are linked to one another.

The embedded security document portion 275A includes an actual copy of the base security document 220 that served as the basis for creating the security. Thus, the blockchain ledger 175 may store copies of all the base security documents 220 used to create securities that are available on the system 100 and the users 105 may access copies of the base security documents 220 directly from the blockchain ledger 175 itself.

The security rules portion 275B specifies the regulatory rules and other restrictions that apply to the issuance or transfer of the security embedded on the blockchain ledger 175. For example, the security rules portion 275 may specify any applicable Blue Sky, FINRA, SEC, BSA regulations, or any rules relating to anti-money laundering, international requirements, or other regulatory measures. The security rules portion 275 may also specify any restrictions which apply to the security (e.g., such as those associated with rights of first refusal, accredited investor statuses, convertible instruments, time restrictions on security transfers, restrictions imposed by the stock series, or other types of restrictions).

When a security trade has been initiated, the content of the security rules portion 275B may be utilized by smart contracts to confirm compliance with all applicable rules and restrictions prior to transferring the security to another user 105. In certain embodiments, the content of the security rules portion 275B includes a dataset that specifies the applicable rules and restrictions and the dataset may be retrieved and utilized by the smart contract to ensure that all rules and restrictions are complied with before a transfer of a security is confirmed. The content of the security rules portion 275B may alternatively, or additionally, include program code and/or scripts which are configured to implement the applicable rules and restrictions and which may be utilized by, or in conjunction with, the smart contract to ensure that all rules and restrictions are complied with before the transfer of a security is confirmed.

The ownership portion 275C of the data block 275 identifies the owner of the security. The ownership portion 275C may initially designate the issuer. Subsequent transactions which transfer ownership of the security may cause new data blocks 275 to be appended to the blockchain ledger 175 which identify the updated owner of the security and which link back to the most recent blocks 275 on the ledger that are associated with the security instrument, thereby providing an audit trail back to the initial data block 275 that was created for the security instrument.

Before a user 105 is permitted to initiate a new security offering or new trade, the user 105 may be required to utilize its cryptographic wallet 125 to access the peer-to-peer network 190 in which the distributed blockchain ledger 175 is maintained by the computing nodes 110. In certain embodiments, the cryptographic wallet 125 may utilize a multi-factor authentication access procedure 210 to access the network 190 and/or to append blocks 275 to the blockchain ledger 175.

The smart contract rules engine 250 may configured to implement any functionality discussed herein with respect to utilizing smart contracts including, but not limited to, any functionality associated with utilizing smart contracts for transferring ownership of securities, onboarding new securities, onboarding issuers, onboarding investors, and utilizing the security rules 275B to ensure compliance with relevant rules and restrictions. In certain embodiments, the smart contract rules engine 250 may incorporated, at least in part, into the cryptographic wallets 125 of the users 105. The smart contract rules engine 250 may alternatively, or additionally, be incorporated into the platform 150.

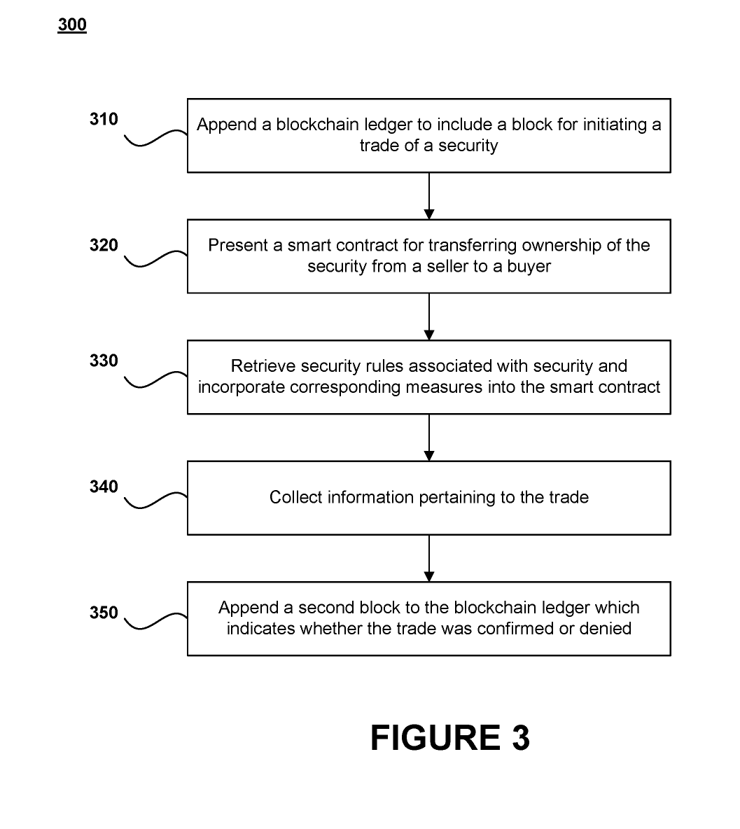

FIG. 3 is a flow diagram that illustrates an exemplary method 300 for transferring ownership of a security in accordance with certain embodiments of the present invention. The exemplary method may be executed whole or part by the cryptographic wallet 125 protocols (e.g., including those associated with the smart contract rules engine 250) and/or platform 150.

In accordance with the method, a block 275 may be appended to a blockchain ledger 175 for initiating a trade of a security (step 310). For example, after an issuer has created a security instrument that is embedded and stored on the blockchain ledger 175, an investor user 105 may submit a request via its cryptographic wallet 125 to purchase the security.

The buyer of the security and the seller of the security may then be presented with a smart contract for transferring ownership of the security from the seller to the buyer (step 320). The smart contract may be accessible to the buyer and the seller via their cryptographic wallets 125. Preferably, the smart contract enables the parties to conduct the transaction and provide all necessary information and documentation electronically, and to sign all documents electronically (e.g., using e-signatures).

Next, security rules associated with the security are retrieved and incorporated as measures into the smart contract (step 330). As mentioned above, a set of regulatory rules (e.g., associated with SEC, FINRA or Blue Sky laws) and other restrictions (e.g., accredited investor status or right of first refusal) may be stored on the blockchain ledger 175 and associated with a security. When the smart contract is initiated, the smart contract may retrieve this information from the blockchain ledger 175 and incorporate appropriate measures into the smart contact to ensure that all regulatory rules and restrictions are complied with before confirming a trade.

In response to receiving the security rules, the smart contract may automatically configure itself to request information and/or attestations pertaining to some or all of the regulatory rules and restrictions to verify that the buyer and seller are complying with the regulatory rules and restrictions associated with the security. For example, the smart contract may require the buyer to attest to an accredited investor status, or may require the buyer to provide information to verify that it is an accredited investor.

The smart contract may also analyze information embedded or stored on the blockchain 175 to determine whether the buyer and seller are complying with the regulatory rules and restrictions associated with the security. For example, in the event that a seller is restricted from selling the security within a predetermined period of time, the smart contract can analyze the blocks 275 associated with the security to determine whether the period of time has lapsed and automatically confirm or deny the contract based on whether this condition was satisfied. Likewise, the smart contract can also analyze the blocks 275 to determine whether a third party having a right of first refusal had previously been offered the contact and automatically confirm or deny the contract based on whether this condition was satisfied.

After the smart contract is configured to incorporate appropriate measures, information is collected which pertains to the trade (step 340). The information may be supplied to verify compliance of the regulatory rules and restrictions and/or to ensure compliance with the other terms of the contract (e.g., to verify that the buyer has available funds which have been placed in escrow). Information may also be supplied which sets the terms of the trade between the buyer and the seller. As explained above, the information may be automatically collected by the smart contract (e.g., by analyzing the blockchain ledger 175) or may be supplied by the parties.

A second block 275 is then appended to the blockchain ledger 175 which indicates whether the trade was confirmed or denied (step 350). If the trade was confirmed, the second block 275 may store information that can be utilized to update and verify the new owner of the security. The second block 275 may further store information that links back to some or all of the other blocks relating to the security on the blockchain ledger 175, including the block 275 that was created for initiating the trade.

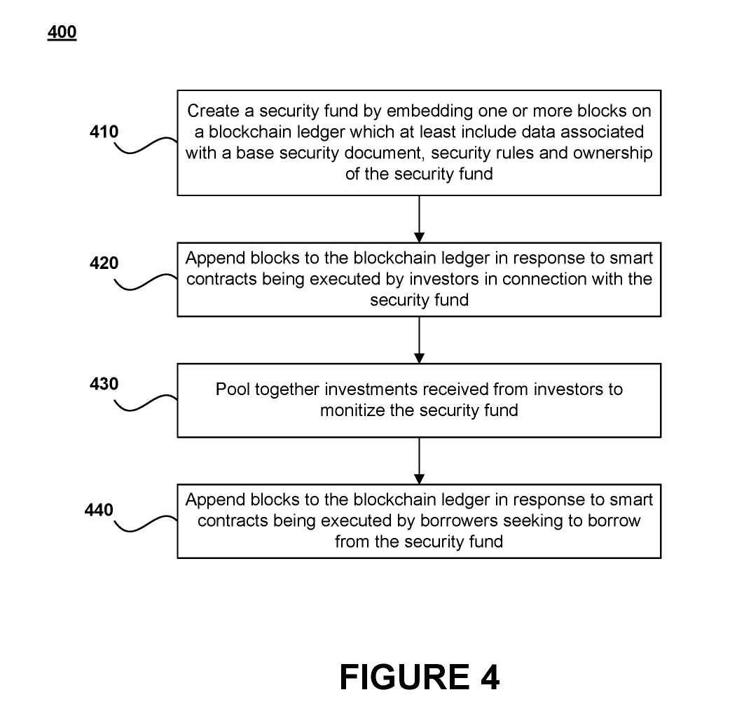

FIG. 4 is a flow diagram that illustrates an exemplary method 400 for implementing a pooled investment fund in accordance with certain embodiments of the present invention. In certain embodiments, the exemplary method may be executed in whole or part by the protocols included in the users' cryptographic wallets 125 (e.g., including those associated with the smart contract rules engine 250) and/or the platform 150.

A security fund is created by embedding one or more blocks on a blockchain ledger 175 which at least include data associated with a base security document, a set of one or more security rules and ownership of the security fund (step 410). The base security document may represent a document that specifies the terms, conditions and other details related to the implementation and management of the security fund. The issuer may initially be designated as the owner of the security fund.

Next, blocks 275 are appended to the blockchain ledger 175 in response to smart contracts being executed by investors in connection with a security fund (step 420). The smart contracts may retrieve the security rules to configure themselves to implement any specified regulations and restrictions. The blocks 275 that are appended to the blockchain ledger 175 may be utilized to update the ownership status of the security fund and may specify investments made by the investors. The blocks 275 may link back to one or more prior blocks on the ledger which are associated with the security fund. One or more corresponding data tokens may then be transferred to each of the investors.

The investments submitted by the investors may be pooled together to monetize the security fund (step 430). When the investors are submitting information in connection with the smart contract, the investors may place money or other currency in escrow to secure payment in connection with the investment. Once the contract is confirmed and the blockchain ledger 175 is appended with a corresponding entry, the money or other currency may be transferred into the investment pool.

Next, blocks 275 are appended to the blockchain ledger 175 in response to smart contracts being executed by borrowers seeking to borrow from the security fund (step 440). The smart contracts may retrieve the security rules to configure themselves to implement any specified regulations and restrictions. The blocks appended to the blockchain ledger 175 may indicate, inter alia, the borrowing amount of each borrower and identity of each borrower. The blocks 275 may link back to one or more prior blocks on the blockchain ledger 175 which are associated with the security fund. One or more corresponding data tokens may then be transferred to each of the investors to represent the borrowing debt associated with the portfolios that are maintained by their cryptographic wallets 125.

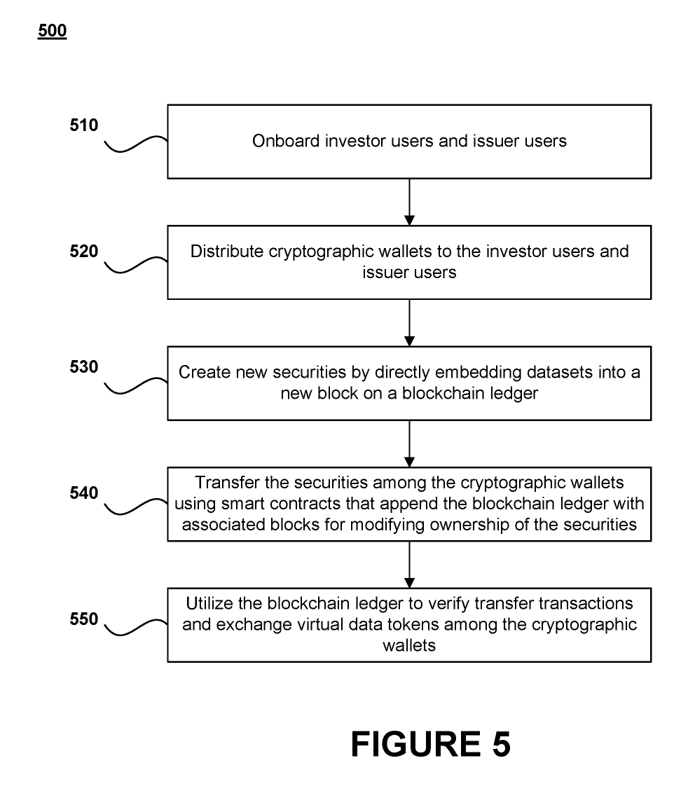

FIG. 5 is a flow diagram that illustrates an exemplary method 500 for managing securities in accordance with certain embodiments of the present invention. The exemplary method may be executed in whole or part by the cryptographic wallet 125 protocols (e.g., including those associated with the smart contract rules engine 250) and/or platform 150.

Investor users 105 and issuer users 105 are onboarded or registered with the system 100 (step 510). As explained above, the users 105 may fill out input forms and provide other information to register as an investor or issuer, and the provided information may or may not be reviewed by an administrator user 105 prior to being approved.

Cryptographic wallets 125 are distributed to the investor users 105 and the issuer users 105 (step 520). The cryptographic wallets 125 permit the users 105 to access a peer-to-peer network 190 that maintains the distributed blockchain ledger 175. The users 105 may utilize the cryptographic wallets 125 to conduct transactions (e.g., issuing, trading, lending, borrowing, etc.) on the network 190. The cryptographic wallets 125 include protocols for dynamically configuring smart contracts associated with these transactions.

Next, new securities are created by directly embedding datasets into a new block 275 on the blockchain ledger 175 (step 530). Each of the datasets may include an embedded security document portion 275A, a security rules portion 275B and an ownership portion 275C. In certain embodiments, the blocks 275 added to the blockchain ledger 175 may include application code or scripts for performing functions associated with conducting issuing, trading, lending or borrowing functions. Exemplary code and scripts may be utilized to ensure compliance with regulatory rules and other restrictions associated with the securities.

The securities may be transferred among the cryptographic wallets 125 of the users 105 using smart contracts that append the blockchain ledger 175 with associated blocks 275 for modifying ownership of the securities (step 540). The smart contracts may utilize the regulatory rules and other restrictions specified in the security rules portion 275B of the block 275 associated with the security instrument to verify that the users 105 comply with all applicable regulations, restrictions and terms.

The blockchain ledger 175 is utilized to verify transfer transactions and virtual data tokens are exchanged among the cryptographic wallets 125 (step 550). The blockchain ledger 175 can be utilized to verify transactions in a variety of different ways. For example, in certain embodiments, before an asset transfer occurs, the cryptographic wallets 125 may analyze the blockchain ledger 175 to identify all relevant blocks 275 that are linked to, or otherwise associated with, the security which is the subject of the transfer. This may permit the cryptographic wallet 125 to confirm that the seller actually owns the security, and that no regulations or restrictions apply which would bar the seller from transferring the security to the buyer.

It should be recognized that numerous variations can be made to the above-described systems and methods without departing from the scope of the invention. For example, although certain embodiments may utilize a decentralized ledger 175 that is implemented without the need for a centralized repository (e.g., on a server) or centralized administrator to process transactions, it should be recognized that alternative embodiments may utilize a centralized blockchain ledger. For example, the platform may utilize a centralized blockchain ledger that is administered by one or more entities that maintain and control the platform, governmental organizations, regulatory authorities, or other private organizations that are licensed to do so.

While various novel features of the invention have been shown, described and pointed out as applied to particular embodiments thereof, it should be understood that various omissions and substitutions and changes in the form and details of the systems and methods described and illustrated, may be made by those skilled in the art without departing from the spirit of the invention. Amongst other things, the steps shown in the methods may be carried out in different orders in many cases where such may be appropriate. Those skilled in the art will recognize, based on the above disclosure and an understanding therefrom of the teachings of the invention, that the particular hardware and devices that are part of the system described herein, and the general functionality provided by and incorporated therein, may vary in different embodiments of the invention. Accordingly, the particular system components are for illustrative purposes to facilitate a full and complete understanding and appreciation of the various aspects and functionality of particular embodiments of the invention as realized in system and method embodiments thereof. Those skilled in the art will appreciate that the invention can be practiced in other than the described embodiments, which are presented for purposes of illustration and not limitation.

What is claimed is:

1. A computerized system for managing securities over a network, the system comprising:
a plurality of computing devices that are in communication with one another over a peer-to-peer communication network that maintains a decentralized blockchain ledger for tracking and recording security transactions, wherein each of the computing devices includes at least one processor and at least one non-transitory physical storage medium that stores:
at least a portion of the decentralized blockchain ledger comprising a distributed database that records information associated with security transactions that occur on the peer-to-peer communication network; and
a cryptographic wallet that includes encryption protocols for securely maintaining a virtual portfolio of securities, the cryptographic wallet at least including:
a first set of protocols for issuing securities, wherein the first set of protocols are configured to store the securities directly on the decentralized blockchain ledger by utilizing a cryptographic hashing algorithm to append one or more blocks to the decentralized blockchain ledger, the one or more blocks at least including base security documents associated with the securities, sets of security rules comprising regulations and restrictions governing the securities, and ownership identifiers which identify one or more owners of the securities, and
a second set of protocols for transferring ownership of the securities to other cryptographic wallets stored on other computing devices in the peer-to-peer communication network;
wherein the first set of protocols and second set of protocols are configured to:
update the distributed database associated with the decentralized blockchain ledger to issue and transfer the securities; and
execute the security transactions using a consensus-based protocol that requires at least a portion of the plurality of computing devices to confirm the security transactions and to append the one or more blocks to the decentralized blockchain ledger.

2. The system of claim 1, wherein the second set of protocols utilizes one or more event-driven smart contracts which are configured to transfer ownership of the securities, the one or more smart contracts being made available through the cryptographic wallet and permitting a buyer and a seller to submit information for satisfying ownership transfer terms.

3. The system of claim 2, wherein the second set of protocols enables the cryptographic wallet to access and retrieve the sets of security rules from the decentralized blockchain ledger and to configure the smart contracts to verify compliance with the regulations and restrictions that apply to the securities.

4. The system of claim 2, wherein a first set of blocks are appended to the decentralized blockchain ledger in response to smart contracts being utilized to initiate security trades and a second set of blocks are appended to the decentralized blockchain ledger to indicate whether or not the security trades are completed or denied.

5. The system of claim 1, wherein the first set of protocols utilize one or more event-driven smart contracts which are configured to onboard new securities to the system, the one or more smart contracts being made available through the cryptographic wallet and permitting a registered issuer to issue new securities.

6. The system of claim 1, wherein the cryptographic wallet enables an issuer to create a security fund that pools together investments from a plurality of investors.

7. The system of claim 6, wherein the cryptographic wallet provides one or more event-driven smart contracts that enable the plurality of investors to contribute to the security fund and to deploy assets from the security fund to a plurality of borrowers.

8. The system of claim 7, wherein the cryptographic wallet is configured to append blocks to the decentralized blockchain ledger associated with investing and borrowing transactions.

9. The system of claim 1, wherein the cryptographic wallet is configured to append blocks to the decentralized blockchain ledger which enable a master account associated with one or more of the securities to assign permissions to one or more sub-accounts.

10. The system of claim 1, wherein:
the base security documents can be accessed directly from the decentralized blockchain ledger;
the decentralized blockchain ledger represents an immutable, append-only ledger;
the cryptographic hashing algorithm utilizes a one-way hashing algorithm to append the one or more blocks to the decentralized blockchain ledger;
the system does not utilize a centralized server to facilitate the security transactions;
the consensus-based protocol requires a specific state or set of values to be agreed upon by the portion of the plurality of computing devices in order to execute the security transactions and to append the one or more blocks to the decentralized blockchain ledger; and
blocks associated with each of the security transactions are linked together to provide an audit trail that can be utilized to track and validate the security transactions.

11. A computer program product for managing securities over a network, the computer program product comprising a non-transitory computer-readable medium including codes for causing a computer device to:
communicate with a plurality of computing devices over a peer-to-peer communication network that maintains a decentralized blockchain ledger for tracking and recording security transactions;
receive at least a portion of the decentralized blockchain ledger comprising a distributed database that records information associated with security transactions that occur on the peer-to-peer communication network; and
store a cryptographic wallet that includes encryption protocols for securely maintaining a virtual portfolio of securities, the cryptographic wallet at least including:
a first set of protocols for issuing securities, wherein the first set of protocols are configured to store the securities directly on the decentralized blockchain ledger by utilizing a cryptographic hashing algorithm that appends one or more blocks to the decentralized blockchain ledger, the one or more blocks at least including base security documents associated with the securities, sets of security rules comprising regulations and restrictions governing the securities, and ownership identifiers which identify one or more owners of the securities, and
a second set of protocols for transferring ownership of the securities to other cryptographic wallets stored on other computing devices in the peer-to-peer communication network;
wherein the first set of protocols and second set of protocols are configured to:
update the distributed database associated with the decentralized blockchain ledger to issue and transfer the securities; and
execute the security transactions using a consensus-based protocol that requires at least a portion of the plurality of computing devices to agree upon the security transactions and to append the one or more blocks to the decentralized blockchain ledger.

12. The computer program product of claim 11, wherein the second set of protocols utilizes one or more event-driven smart contracts which are configured to transfer ownership of the securities, the one or more smart contracts being made available through the cryptographic wallet and permitting a buyer and a seller to submit information for satisfying ownership transfer terms.

13. The computer program product of claim 12, wherein the second set of protocols enables the cryptographic wallet to access and retrieve the sets of security rules from the decentralized blockchain ledger and to configure the smart contracts to verify compliance with the regulations and restrictions that apply to the securities.

14. The computer program product of claim 12, wherein a first set of blocks are appended to the decentralized blockchain ledger in response to smart contracts being utilized to initiate security trades and a second set of blocks are appended to the decentralized blockchain ledger to indicate whether or not the security trades are completed or denied.

15. The computer program product of claim 11, wherein the first set of protocols utilize one or more event-driven smart contracts which are configured to onboard new securities to the system, the one or more smart contracts being made available through the cryptographic wallet and permitting a registered issuer to issue new securities.

16. The computer program product of claim 11, wherein the cryptographic wallet enables an issuer to create a security fund that pools together investments from a plurality of investors.

17. The computer program product of claim 16, wherein the cryptographic wallet provides one or more event-driven smart contracts that enable the plurality of investors to contribute to the security fund and to deploy assets from the security fund to a plurality of borrowers.

18. The computer program product of claim 17, wherein the cryptographic wallet is configured to append blocks to the decentralized blockchain ledger associated with investing and borrowing transactions.

19. The computer program product of claim 11, wherein the cryptographic wallet is configured to append blocks to the decentralized blockchain ledger which enable a master account associated with one or more of the securities to assign permissions to one or more sub-accounts.

20. The computer program product of claim 11, wherein:
the base security documents can be accessed directly from the decentralized blockchain ledger;
the decentralized blockchain ledger represents an immutable, append-only ledger;
the cryptographic hashing algorithm utilizes a one-way hashing algorithm to append the one or more blocks to the decentralized blockchain ledger;
the system does not utilize a centralized server to facilitate the security transactions;
the consensus-based protocol requires a specific state or set of values to be agreed upon by the portion of the plurality of computing devices in order to execute the security transactions and to append the one or more blocks to the decentralized blockchain ledger; and
blocks associated with each of the security transactions are linked together to provide an audit trail that can be utilized to track and validate the security transactions.
